(19) United States
(12) Patent Application Publication
(10) Pub. No.: US 2019/0061387 A1
(43) Pub. Date: Feb. 28, 2019

(54) IMAGE FORMING APPARATUS

(71) Applicant: KONICA MINOLTA, INC., Tokyo (JP)

(72) Inventor: Toshiaki Tomino, Tokyo (JP)

(73) Assignee: KONICA MINOLTA, INC., Tokyo (JP)

(21) Appl. No.: 16/022,155

(22) Filed: Jun. 28, 2018

(30) Foreign Application Priority Data
Aug. 30, 2017 (JP) 2017-164946

(51) Int. Cl. B41J 13/00; B65H 23/04; B65H 23/038; B41J 11/00; B41J 15/04

(52) U.S. Cl. CPC B41J 13/0009; B65H 23/046; B41J 15/04; B41J 11/0095; B65H 23/038

(57) ABSTRACT

Provided is an image forming apparatus with rollers capable of coming into contact with or leaving a recording medium, in which meandering of the recording medium is suppressed. The apparatus includes a tension adjuster for adjusting a tension applied to the recording medium nipped between a plurality of roller pairs. The tension adjuster is located upstream of, among the roller pairs, the most upstream roller pair located on the most upstream side in the conveyance path or downstream of, among the roller pairs, the most downstream roller pair located on the most downstream side in the conveyance path and the tension adjuster rotates in the direction of conveyance of the recording medium to adjust the tension of the recording medium.

### CROSS-REFERENCE TO RELATED APPLICATIONS

The entire disclosure of Japanese Patent Application No. 2017-164946, filed on Aug. 30, 2017, is incorporated herein by reference in its entirety.

### BACKGROUND

### Technological Field

The present invention relates to image forming apparatuses such as copiers and ink jet recorders and more particularly to image forming apparatuses which use a recording medium such as roll paper.

### Description of the Related Art

In the past, image forming apparatuses such as an electro-photographic image forming apparatus in which a toner image formed on a photoreceptor is transferred to a recording medium by a transfer roller and heated and pressurized by a fixing roller to fix the toner image, and an ink jet image forming apparatus which injects ink while heating a recording medium by a preheat roller have been widely used.

Furthermore, an image forming apparatus which conveys a long recording medium such as roll paper with a given tension applied to the medium and if the medium meanders, uses a meandering attenuator to attenuate the meandering is known (Patent Literature 1).

### CITATION LIST

### Patent Literature

Patent Literature 1: JP-A-2016-188115

### SUMMARY

In an image forming apparatus, if the transfer roller or the like is constantly held pressed against the recording medium, it would deform, so the transfer roller or the like is structured to be able to come into contact with and leave the recording medium. For this reason, misalignment in the roller contact position may occur during the motion of coming into contact with or leaving and this misalignment may cause a change in the tension applied to the recording medium, resulting in meandering of the recording medium.

The present invention has an object to suppress meandering of the recording medium in an image forming apparatus with rollers capable of coming into contact with or leaving the recording medium.

To solve the above problem and achieve at least one of the abovementioned objects, according to an aspect of the present invention, an image forming apparatus reflecting one aspect of the present invention includes: a plurality of roller pairs provided along a conveyance path and capable of coming into contact with and leaving the recording medium; and a tension adjuster for adjusting a tension applied to the recording medium held between the plural roller pairs. The tension adjuster is located upstream of, among the roller pairs, the most upstream roller pair located on the most upstream side in the conveyance path or downstream of, among the roller pairs, the most downstream roller pair located on the most downstream side in the conveyance path, and rotates in the direction of conveyance of the recording medium to adjust the tension of the recording medium.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic configuration diagram of an image forming apparatus according to a first embodiment of the present invention;

FIG. 2 is a block diagram which shows the control system of the image forming apparatus according to the first embodiment;

FIGS. 3A to 3D illustrate the mechanism by which the paper being conveyed meanders, in which FIG. 3A shows inclination of the fixing roller pair, FIG. 3B shows inclination of the downstream end of the paper, FIG. 3C shows movement of the paper toward the nearer side, and FIG. 3D shows movement of the paper toward the farther side;

FIG. 4 is a graph which shows the relation between the behavior of meandering paper and the amount of deviation;

FIGS. 5A to 5C are graphs which show the relation between misalignment of roller pairs and the amount of deviation of the paper, in which FIG. 5A shows misalignment of the paper discharge roller pair, FIG. 5B shows misalignment of the fixing roller pair, and FIG. 5C shows misalignment of the transfer roller pair;

FIG. 6 is a schematic configuration diagram of the image forming apparatus according to the first embodiment of the invention;

FIG. 7 is a perspective view of an adjustment roller pair of the roller type according to the first embodiment of the invention;

FIGS. 8A to 8C are conceptual diagrams which show the movement of the adjustment roller pair of the conveying roller type, in which FIG. 8A shows the support shaft fixed in the center, FIG. 8B shows the support shaft fixed on the farther side, and FIG. 8C shows the support shaft fixed on the nearer side;

FIG. 9 is a perspective view of an adjustment roller pair of the winding roller type according to a variation of the first embodiment of the invention;

FIGS. 10A to 10C are conceptual diagrams which show the movement of the adjustment roller pair of the winding roller type, in which FIG. 10A shows the support shaft fixed in the center, FIG. 10B shows the support shaft fixed on the farther side, and FIG. 10C shows the support shaft fixed on the nearer side;

FIGS. 11A to 11C are diagrams which explain the procedure of correcting meandering of the paper using the adjustment roller pair 80, in which FIG. 11A shows the paper end position on the guide scale in normal conveyance, FIG. 11B shows the paper end position on the guide scale in misalignment, and FIG. 11C shows rotation of the adjustment knob;

FIG. 12 is a schematic configuration diagram of the image forming apparatus according to a variation of the first embodiment of the invention;

FIG. 13 is a schematic configuration diagram of an ink jet recorder according to a second embodiment of the invention;

FIG. 14 is a schematic configuration diagram of an ink jet recorder according to a variation of the second embodiment of the invention;

FIG. 15 is a flowchart which explains the control of paper conveyance in the image forming apparatus according to the first embodiment; and

FIG. 16 is a flowchart which explains the control for correction of meandering in the image forming apparatus according to the first embodiment.

### DETAILED DESCRIPTION OF EMBODIMENTS

Hereinafter, one or more embodiments of the present invention will be described with reference to the drawings. However, the scope of the invention is not limited to the disclosed embodiments.

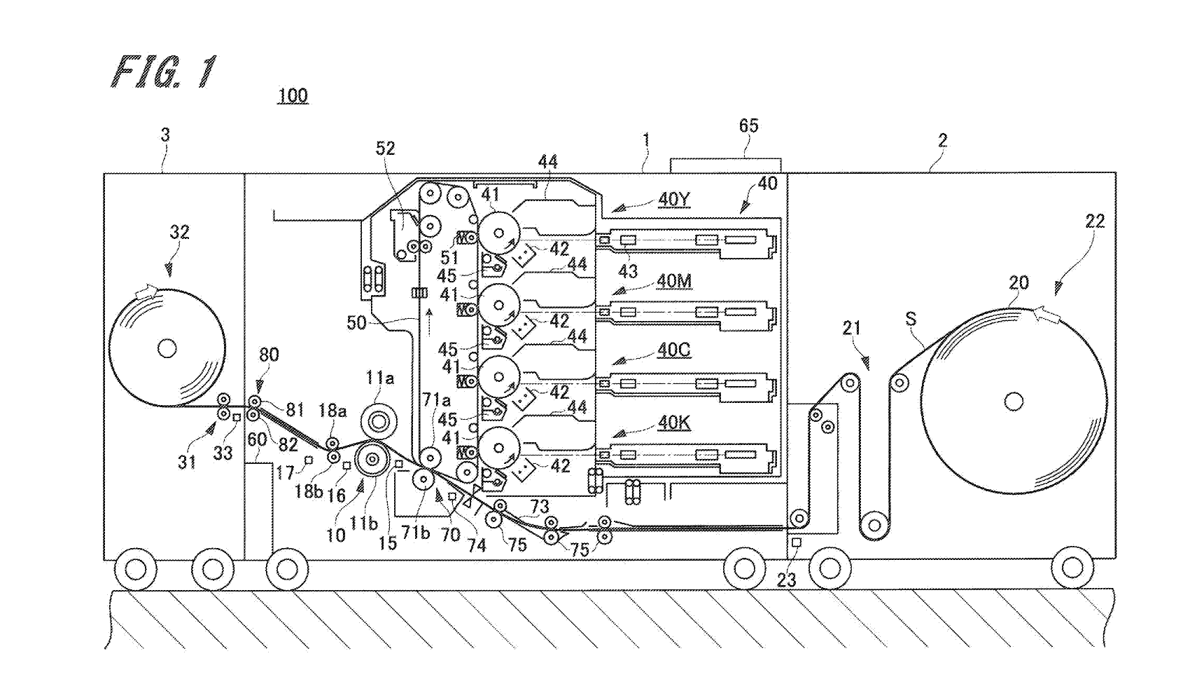

FIG. 1 is a schematic configuration diagram of an image forming apparatus 100 according to the first embodiment. The image forming apparatus 100 includes an image forming main unit 1, a paper feed unit 2 for feeding roll paper S to the image forming main unit 1, and a paper discharge unit 3 for winding up the discharged roll paper S from the image forming main unit 1.

### [Configuration of the Image Forming Apparatus]

First, the image forming main unit 1 is explained below. The image forming main unit 1 is a tandem color image forming device based on an electro-photographic method to form an image on roll paper S, in which four color toners, yellow (Y), magenta (M), cyan (C), and black (Bk), are superimposed one upon another.

As shown in FIG. 1, the image forming main unit 1 includes a conveyor 73, an image forming section 40, an intermediate transfer belt 50, a secondary transfer part 70, a fixing section 10, an operation display 65, and a controller 60.

The conveyor 73 includes a plurality of conveying rollers 75 provided upstream of the secondary transfer part 70 to convey the roll paper S conveyed from the paper feed unit 2 to the secondary transfer part 70 as a transfer position.

The image forming section 40 includes four image forming units 40Y, 40M, 40C and 40K to form color toner images of yellow (Y), magenta (M), cyan (C), and black (Bk).

The first image forming unit 40Y forms a yellow toner image and the second image forming unit 40M forms a magenta toner image. The third image forming unit 40C forms a cyan toner image and the fourth image forming unit 40K forms a black toner image. These four image forming units 40Y, 40M, 40C, and 40K have the same structure. Therefore, the first image forming unit 40Y, as a representative of the four image forming units, is described below.

The image forming unit 40Y includes a drum-like photoreceptor 41, an electrifying part 42 placed around the photoreceptor 41, an exposure part 43, a development part 44, and a cleaning device 45. The photoreceptor 41 is driven by a drive motor (not shown) to rotate counterclockwise. The electrifying part 42 gives electric charge to the photoreceptor 41 to electrify the surface of the photoreceptor 41 evenly. The exposure part 43 scans and exposes the surface of the photoreceptor 41 to light according to the image data sent from outside to form an electrostatic latent image on the photoreceptor 41.

The development part 44 makes the yellow toner adhere to the electrostatic latent image formed on the photoreceptor 41. Consequently, a yellow toner image is formed on the surface of the photoreceptor 41. The development part 44 of the second image forming unit 40M makes the magenta toner adhere to the photoreceptor 41 and the development part 44 of the third image forming unit 40C makes the cyan toner adhere to the photoreceptor 41. The development part 44 of the fourth image forming unit 40K makes the black toner adhere to the photoreceptor 41.

The toner adhering to the photoreceptor 41 is transferred to the intermediate transfer belt 50. The cleaning device 45 removes residual tonner on the surface of the photoreceptor 41 after the toner is transferred to the intermediate transfer belt 50.

The intermediate transfer belt 50 is endless and rotated by a drive motor (not shown) clockwise, or in the direction opposite to the direction of rotation of the photoreceptor 41. A primary transfer part 51 is provided on the intermediate transfer belt 50 in a position to face the photoreceptor 41 of each of the image forming units 40Y, 40M, 40C, and 40K. The primary transfer part 51 transfers the toner image formed on the photoreceptor 41 to the intermediate transfer belt 50 by applying a voltage with opposite polarity to the polarity of the toner to the intermediate transfer belt 50.

As the intermediate transfer belt 50 rotates, the toner images formed by the four image forming units 40Y, 40M, 40C, and 40K are sequentially transferred to the surface of the intermediate transfer belt 50. Consequently, the yellow, magenta, cyan, and black toner images are superimposed to form a color image on the intermediate transfer belt 50.

A transfer roller pair 71 as the secondary transfer part 70 is provided near the intermediate transfer belt 50 and downstream of the conveyor 73. The transfer roller pair 71 includes an upper transfer roller 71a across which the intermediate transfer belt 50 is laid, and a lower transfer roller 71b to be pressed toward the upper transfer roller 71a with the intermediate transfer belt 50 between the upper and lower rollers. These rollers are structured to be able to come into contact with and leave the roll paper S.

At the secondary transfer part 70, the roll paper S conveyed by the conveyor 73 including a conveying roller pair 75 is pressed against the intermediate transfer belt 50 by the lower transfer roller 71b. Then, the secondary transfer part 70 transfers the color toner image formed on the intermediate transfer belt 50 to the paper S conveyed from the conveyor 73. After transferring the image to the roll paper S, a cleaning section 52 removes residual toner on the surface of the intermediate transfer belt 50.

A pre-transfer sensor 74 as a measuring point is provided near the transfer roller pair 71 upstream of the transfer roller pair 71 in the paper conveyance direction. The pre-transfer sensor 74 detects the presence/absence of paper (roll paper S) and the position of the end of roll paper S in the paper width direction on the upstream side of the transfer roller pair 71. The value detected by the pre-transfer sensor 74 is sent to an arithmetic section 29 which calculates the amount of meandering (deviation) from the correct position of the roll paper S. For example, the pre-transfer sensor 74 is an optical sensor or has a mechanism such as a mechanical switch.

A fixing roller pair 11 as the fixing section 10 includes a fixing roller 11a and a pressure roller 11b as a pressurizing member which are structured to be able to come into contact with and leave the roll paper S.

The area where the fixing roller 11a and the pressure roller 11b come into contact with each other forms a nip part. As the roll paper S bearing the toner image passes through the nip part of the fixing section 10, the toner is melted by the fixing roller 11a and pressure roller 11b which are controlled at a prescribed temperature, and fixed on the roll paper S.

A post-transfer sensor 15 as a measuring point is provided near the nip part formed by the fixing roller 11a and pressure roller 11b and upstream of the nip part in the paper conveyance direction. The post-transfer sensor 15 detects the presence/absence of paper (roll paper S) and the position of the end of roll paper S in the paper width direction on the downstream side of the secondary transfer part 70. The value detected by the post-transfer sensor 15 is sent to the arithmetic section 29 which calculates the amount of meandering from the correct position of the roll paper S.

A post-fixing sensor 16 as a measuring point is provided near the nip part formed by the fixing roller 11a and pressure roller 11b and downstream of the nip part in the paper conveyance direction. The post-fixing sensor 16 detects the presence/absence of paper (roll paper S) and the position of the end of the roll paper S in the paper width direction on the downstream side of the fixing roller pair 11. The value detected by the post-fixing sensor 16 is sent to the arithmetic section 29 which calculates the amount of meandering from the correct position of the roll paper S.

A paper discharge roller pair 18 is provided downstream of the post-fixing sensor 16 to covey the roll paper S bearing the toner image fixed by the fixing roller pair 11, to the paper discharge unit 3. The paper discharge roller pair 18 includes an upper discharge roller 18a and a lower discharge roller 18b and is structured to be able to come into contact with and leave the roll paper S.

An adjustment roller pair 80 as a tension adjuster for correcting meandering of paper is provided downstream of the paper discharge roller pair 18. The adjustment roller pair 80 includes a first adjustment roller 81 and a second adjustment roller 82 and also serves as a paper discharger which discharges the roll paper S to the paper discharge unit 3.

A post-discharge sensor 17 as a measuring point is provided downstream of the paper discharge roller pair 18 and upstream of the adjustment roller pair 80. The post-discharge sensor 17 detects the presence/absence of paper and the position of the end of the roll paper S in the paper width direction on the downstream side of the paper discharge roller pair 18. The value detected by the post-discharge sensor 17 is sent to the arithmetic section 29 which calculates the amount of meandering from the correct position of the roll paper S.

The operation display 65 is a touch panel which includes a display such as a liquid crystal display (LCD) or organic ELD (Electro Luminescence Display). The operation display 65 shows a menu of instructions to the user, information related to acquired image data and so on. In addition, the operation display 65 includes a plurality of keys and has a function as an input unit which receives data entered through key operation by the user, including various instructions, characters, and numerals.

The controller 60 controls various components of the image forming main unit 1 according to an instruction from the operation display 65 or a personal computer 120 connected to an external device.

### [Paper Feed Unit and Paper Discharge Unit]

Next, the paper feed unit 2 and paper discharge unit 3 will be described. The paper feed unit 2 includes a roll paper holder 22, a conveyor 21, and a paper feed sensor 23. In the roll paper holder 22, a roll paper body 20 around which the desired roll paper is wound is set in a rotatable manner. The conveyor 21 includes a plurality of conveying rollers and conveys the roll paper S unwound from the roll paper holder 22 to the image forming main unit 1. The paper feed sensor 23 is, for example, located near the exit port where the roll paper S in the paper feed unit 2 is sent to the image forming main unit 1, to detect whether or not paper (roll paper S) exists at a position facing the paper feed sensor 23.

The paper discharge unit 3 includes a paper discharge sensor 33, a conveyor 31, and a take-up part 32. The paper discharge sensor 33 is located near the inlet port for the roll paper S discharged from the image forming main unit 1 to the paper discharge unit 3, to detect whether or not paper (roll paper S) exists at a position facing the paper discharge sensor 33. The conveyor 31 includes a plurality of conveying rollers and conveys the roll paper S discharged to the paper discharge unit 3 by the discharge roller pair 18 and adjustment roller pair 80, to the take-up part 32. The take-up part 32 winds up the conveyed roll paper S in the form of a roll.

### [Configuration of the Control System]

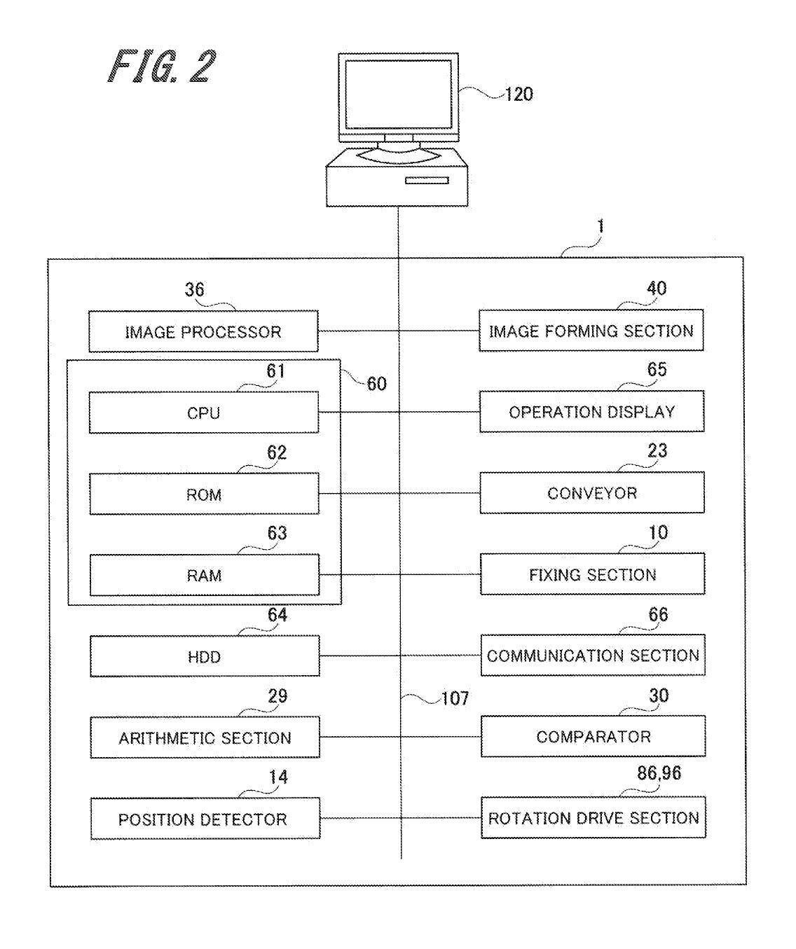

FIG. 2 is a block diagram which shows the internal configuration of the image forming main unit 1 of the image forming apparatus 100. As shown in FIG. 2, the image forming main unit 1 includes a controller 60, an image processor 36, an image forming section 40, an operation display 65, a conveyor 73, a HDD 64, a fixing section 10, an arithmetic section 29, a comparator 30, a communication section 66, and a rotation drive section 86.

The controller 60, for example, includes a CPU (Central Processing Unit) 61, a ROM (Read Only Memory) 62 for storing the program to be executed by the CPU 61 or the like, and a RAM (Random Access Memory) 63 to be used as a working area for the CPU 61. For the ROM 62, usually an electrically erasable programmable ROM is used.

The controller 60 is connected to the image processor 36, image forming section 40, operation display 65, conveyor 73, HDD 64, fixing section 10, arithmetic section 29, comparator 30, rotation drive section 86, position detector 14 including the post-transfer sensor 15, post-fixing sensor 16, and post-discharge sensor 17, and communication section 66 through a system bus 107 to control the entire image forming main unit 1. Furthermore, the controller 60 controls various components of the paper feed unit 2 and paper discharge unit 3 through the communication section 66. In short, in this example, the controller 60 controls the entire image forming apparatus 100.

The image data sent from the PC (personal computer) as an example of the external device connected to the image forming main unit 1 is sent to the image processor 36 and in the image processor 36, the image data is subjected to image processing. The image processor 36 performs image processing tasks such as shading correction, image density adjustment, and image compression, on the received image data as necessary under the control by the controller 60. The image forming section 40 receives the image data processed by the image processor 36 under the control by the controller 60 and forms an image on roll paper S according to the image data.

The communication section 66 is a communication interface for connection to the network to which various units constituting the image forming apparatus 100 are connected. For example, the image forming main unit 1 makes serial communication with the paper feed unit 2 and paper discharge unit 3 through the communication section 66.

### Mechanism of Meandering]

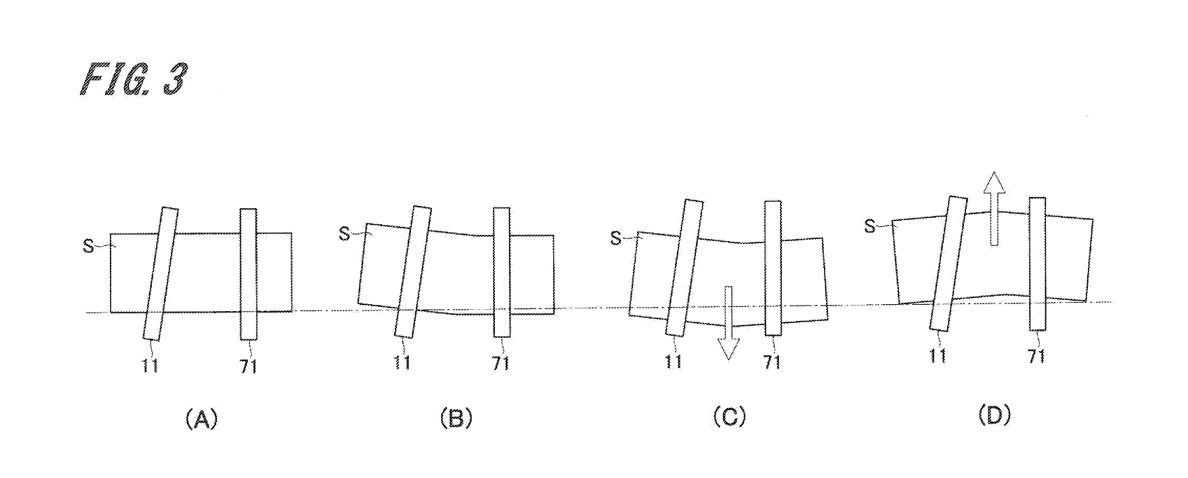

Next, the mechanism by which the roll paper S being conveyed meanders in the image forming apparatus 100 will be explained referring to FIGS. 3A to 3D.

FIGS. 3A to 3D are schematic top views of the conveyance path in the image forming main unit 1, in which the roll paper S is conveyed, showing that the fixing roller pair 11 is located downstream of the transfer roller pair 71 in the paper conveyance direction.

FIG. 3A shows a state in which, after leaving the roll paper S, the fixing roller pair 11 again comes into contact with the roll paper S in order to restart a print job and holds the roll paper S in the nip part of the fixing roller pair 11. In this state, before the fixing roller pair 11 leaves the paper and after it comes into contact with the paper, the fixing roller pair 11 is inclined and out of alignment with the transfer roller pair 71. As shown in FIG. 3A, misalignment in this case is a state in which the distance between the fixing roller pair 11 and the transfer roller pair 71 is larger on the nearer side in the width direction of the roll paper S and the distance between the fixing roller pair 11 and the transfer roller pair 71 is smaller on the farther side in the width direction of the roll paper S.

Generally, when the distance between rollers which simultaneously nip and convey the paper is increased, the tension applied to the paper becomes higher because the paper end is pulled by the rollers. On the other hand, when the distance between the rollers is decreased, the paper end slacks and the tension applied to the paper end becomes lower.

As shown in FIG. 3B, the fixing roller pair 11 is inclined with respect to the transfer roller pair 71 and thus the nipped roll paper S is conveyed with the paper portion downstream of the fixing roller pair 11 inclined toward the direction perpendicular to the axis of the fixing roller pair 11.

As shown in FIG. 3 C, the tension of the roll paper S nipped by the transfer roller pair 71 and fixing roller pair 11 is higher on the nearer side in the width direction as mentioned above and thus as indicated by the arrow in the figure, the inclined roll paper S moves toward the nearer side in the width direction, causing the roll paper S to start meandering.

The roll paper S, which has been conveyed while meandering toward the nearer side in the width direction of the roll paper S, then moves toward the farther side in the width direction of the roll paper S as indicated by the arrow in FIG. 3D. When the roll paper S is conveyed by the adjacent rollers which are out of alignment in this way, the roll paper S is conveyed while meandering with a behavior like string vibration. It is known that when the tension applied to the paper is higher, the amount of meandering is smaller and the time until attenuation of meandering is shorter.

### [Amount of Deviation of Paper]

The present inventors have conducted a study on meandering (amount of deviation) of the paper being conveyed which occurs due to misalignment of a roller pair, provided that the transfer roller pair 71, fixing roller pair 11, and paper discharge roller pair 18 are arranged in order from the upstream side in the paper conveyance direction.

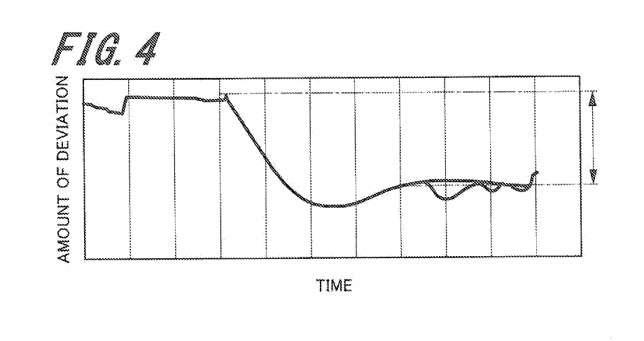

First, the amount of deviation of paper will be described referring to FIG. 4.

FIG. 4 is a graph which shows the behavior of paper when meandering (deviation) occurs in the paper being conveyed. In the graph, the horizontal axis represents elapsed time and the vertical axis represents the amount of deviation of a widthwise end of the paper from the standard position. For the amount of deviation, the standard position is the position of the paper as detected just before a roller pair comes into contact with the paper.

As mentioned above, it is known that when the roll paper S is conveyed using a plurality of misaligned rollers, meandering with a behavior like string vibration occurs in the roll paper S and the meandering attenuates after a given time has elapsed. From the graph, it can be understood that meandering with a behavior like string vibration attenuates upon the lapse of a given time and the stable conveyance condition is restored. Here, the amount of deviation of the paper is taken as the difference between the position of the paper just before contact with the roller pair and the stable paper position restored after attenuation of meandering, which is expressed as the range indicated by the arrow in the graph.

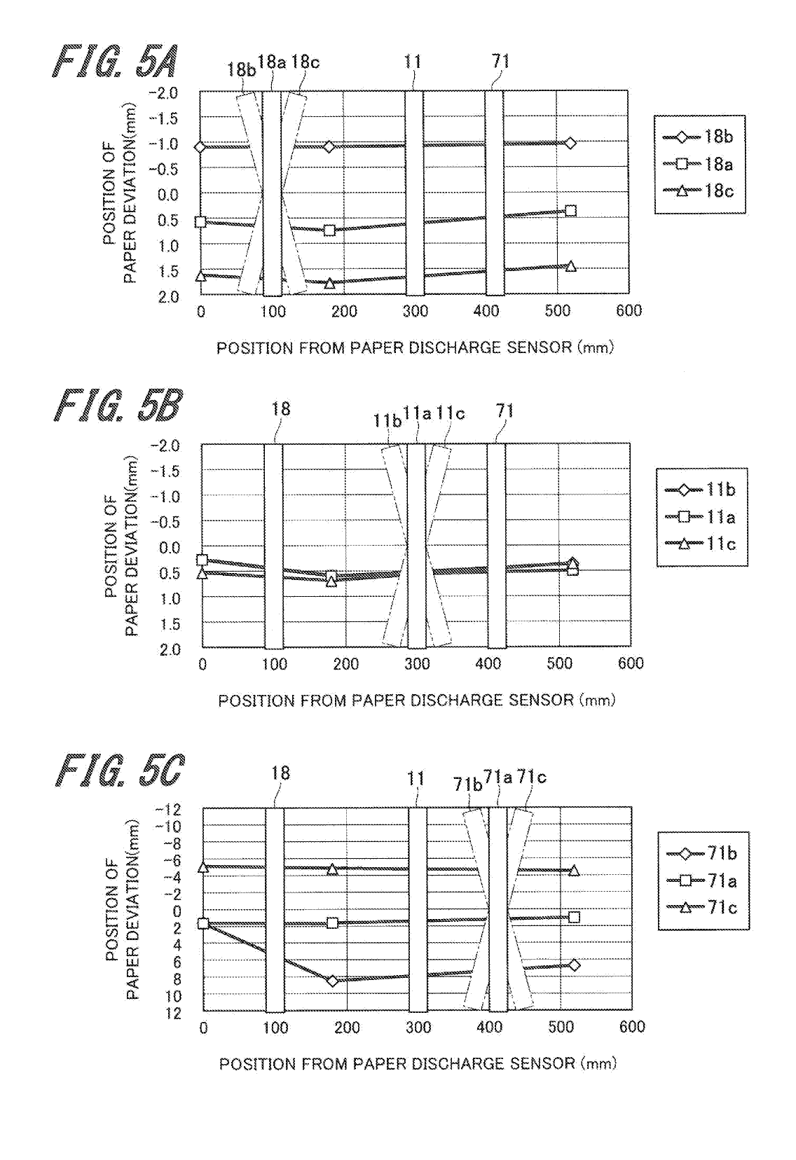

FIGS. 5A to 5C are graphs which show the amount of deviation of the paper as measured when the paper discharge roller pair 18, fixing roller pair 11, and transfer roller pair 71 are out of alignment, respectively.

FIG. 5A is a graph which shows a case that the paper discharge roller pair 18, located on the most downstream side in the paper conveyance direction, is out of alignment.

In the graph, the horizontal axis represents the distance from the position where a position detection sensor is located, and the vertical axis represents the position (amount) of deviation of the paper. As for the numerical values on the vertical axis, 0 denotes that the paper does not deviate, − denotes that the farther side of the paper in the width direction deviates, and + denotes that the nearer side of the paper in the width direction deviates.

As shown in FIG. 5A, if the paper discharge roller pair 18 is not out of alignment (18a), deviation of the paper is very little though the paper slightly deviates toward the nearer side. The figure also indicates that when the farther side of the paper discharge roller pair 18 in the width direction of the paper is inclined or out of alignment in a manner to increase the distance from the fixing roller pair 11 (18b), the paper largely deviates toward the farther side. Furthermore, the figure indicates that when the nearer side of the paper discharge roller pair 18 in the width direction of the paper is inclined or out of alignment in a manner to increase the distance from the fixing roller pair 11 (18c), the paper largely deviates toward the nearer side.

FIG. 5B is a graph which shows a case that the fixing roller pair 11, located between the transfer roller pair 71 and the paper discharge roller pair 18, is out of alignment.

FIG. 5B indicates that if the fixing roller pair 11 is not out of alignment (11a), deviation of the paper is very little though the paper slightly deviates toward the nearer side. The figure also indicates that even when the farther side of the fixing roller pair 11 in the width direction of the paper is inclined or out of alignment in a manner to increase the distance from the transfer roller pair 71 (to decrease the distance to the paper discharge roller pair 18) (11b), deviation of the paper is very little. Furthermore, the figure indicates that even when the nearer side of the fixing roller pair 11 in the width direction of the paper is inclined or out of alignment in a manner to increase the distance from the transfer roller pair 71 (to decrease the distance to the paper discharge roller pair 18) (11c), deviation of the paper is very little.

FIG. 5C is a graph which shows a case that the transfer roller pair 71, located on the most upstream side, is out of alignment.

FIG. 5C indicates that if the transfer roller pair 71 is not out of alignment (71a), deviation of the paper is very little though the paper slightly deviates toward the nearer side. The figure also indicates that when the nearer side of the transfer roller pair 71 in the width direction of the paper is inclined or out of alignment in a manner to increase the distance from the fixing roller pair 11 (71b), the paper largely deviates toward the nearer side. Furthermore, the figure indicates that when the farther side of the transfer roller pair 71 in the width direction of the paper is inclined or out of alignment in a manner to increase the distance from the fixing roller pair 11 (71c), the paper largely deviates toward the farther side.

The above result suggests that for the transfer roller pair 71 on the most upstream side in the paper conveyance path and the paper discharge roller pair 18 on the most downstream side, if misalignment occurs in a manner that the distance from the adjacent rollers increases, the tension on the side where the distance has increased becomes higher and the tension on the side where the distance has decreased becomes lower and as a consequence, the paper largely deviates toward the higher tension side.

On the other hand, for the fixing roller pair 11 located between the transfer roller pair 71 and the paper discharge roller pair 18, since the roller pairs 18 and 71 exist on the both sides of the fixing roller pair 11, if misalignment occurs in a manner to increase the distance from one adjacent roller pair, the distance to the other adjacent roller pair should decrease. For example, if the farther side of the fixing roller pair 11 in the width direction of the paper is inclined or out of alignment in a manner to increase the distance from the transfer roller pair 71 (to decrease the distance to the paper discharge roller pair 18), the tension between the fixing roller pair 11 and the transfer roller pair 71 becomes higher but the tension between the fixing roller pair 11 and the paper discharge roller pair 18 becomes lower and as a consequence, the change in tension as caused by misalignment is offset and the paper does not meander.

This means that when a plurality of roller pairs exist in the paper conveyance path, even if a tension adjuster for adjusting the tension of the paper by misalignment is provided between the rollers located on the most upstream side and the rollers located on the most downstream side, the existence of adjacent rollers on both sides offsets the change in tension, thereby making it impossible to correct the meandering of the paper.

Based on the above observation, this embodiment is explained below referring to the schematic diagram of the image forming apparatus 100.

FIG. 6 is a schematic configuration diagram of the image forming apparatus 100 shown in FIG. 1.

As shown in FIG. 6, the image forming apparatus 100 includes an image forming main unit 1, a paper feed unit 2 with a conveyor 21, and a paper discharge unit 3 with a take-up part 32.

In the conveyance path in the image forming main unit 1, the conveying roller pair 75, transfer roller pair 71, fixing roller pair 11, paper discharge roller pair 18, and adjustment roller pair 80 are arranged in order from upstream. In short, the adjustment roller pair 80 as a tension adjuster is located downstream of the paper discharge roller pair 18 as the most downstream roller pair. The transfer roller pair 71, fixing roller pair 11, and paper discharge roller pair 18 are structured to be able to come into contact with and leave the paper being conveyed and these rollers may get out of alignment while they are moving to come into contact with or leave the paper.

Next, the adjustment roller pair as a tension adjuster will be described in detail.

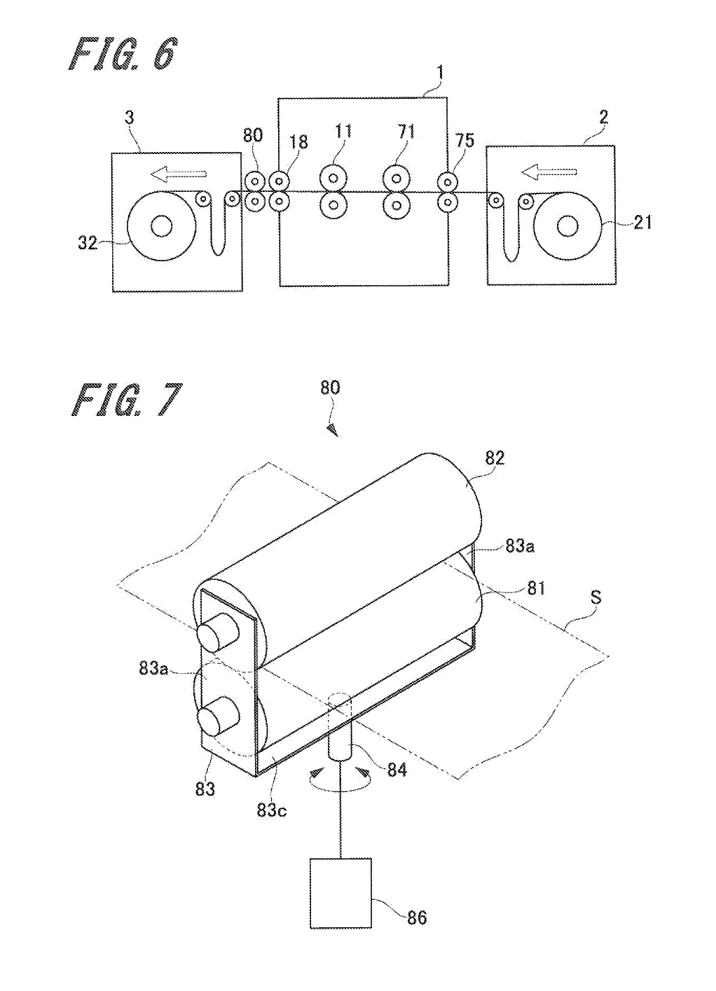

FIG. 7 is a perspective view of the adjustment roller pair 80 of the roller type with a nip.

As shown in FIG. 7, the adjustment roller pair 80 includes a first adjustment roller 81 and a second adjustment roller 82 provided above the first adjustment roller 81. The first adjustment roller 81 and second adjustment roller 82 are each a roller member whose axial length is larger than the widthwise length of the roll paper S.

The first adjustment roller 81 and second adjustment roller 82 are supported by a roller support 83 in a manner that the axes of the rollers are parallel to each other in the vertical direction. The roller support 83 includes a bottom part 83c provided along the conveyance direction of the roll paper S and sidewall parts 83a erected opposite to each other with the bottom part 83c sandwiched and these members form a U-shaped cross section in the width direction of the roll paper S.

A support shaft 84 which rotates the roller support 83 on a plane parallel to the surface of the roll paper S with the first adjustment roller 81 and second adjustment roller 82 supported is fixed on the bottom part 83c of the roller support 83. The support shaft 84 is connected to the rotation drive section 86 as a rotation controller. As the rotation drive section 86 rotates the support shaft 84, the roller support 83 fixed on the support shaft 84 rotates on the plane parallel to the surface of the roll paper S with the support shaft 84 as a rotation axis.

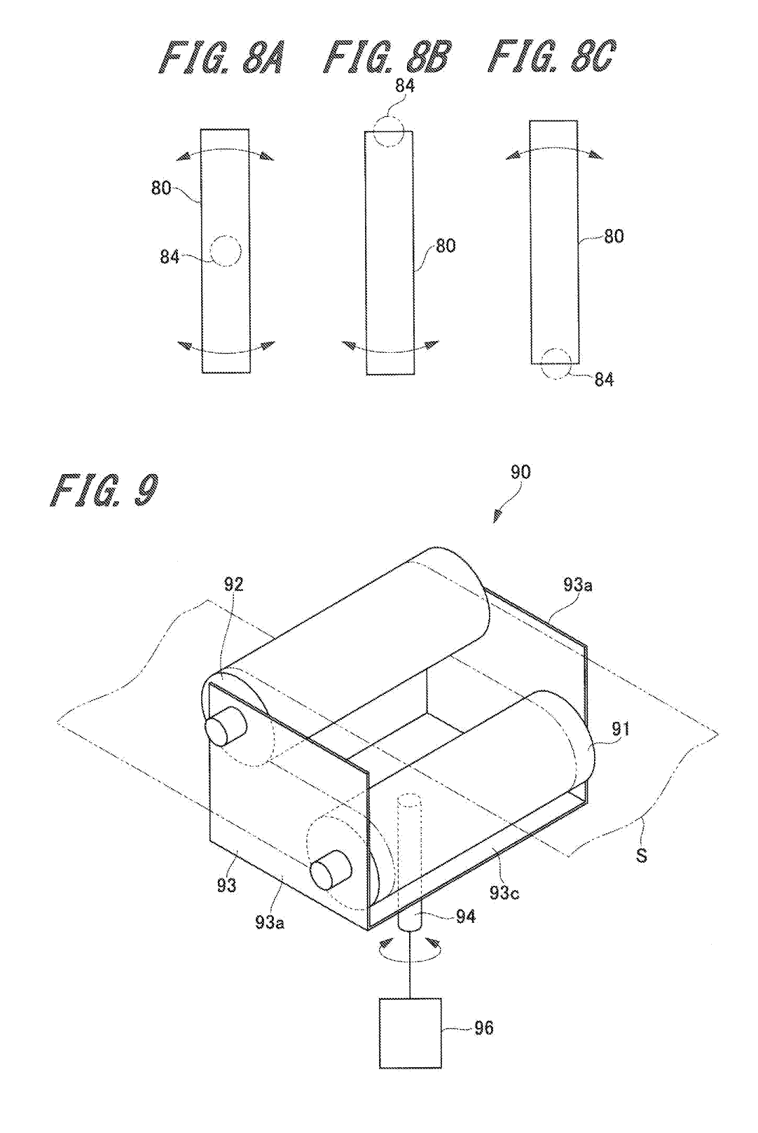

FIGS. 8A to 8C are conceptual diagrams which show the movement of the adjustment roller pair 80 when the support shaft 84 is fixed in different positions. The figures are top views of the adjustment roller pair 80 in the conveyance path.

FIG. 8A shows a case that the support shaft 84 is fixed in the widthwise center of the roll paper S.

As shown in FIG. 8A, the support shaft 84 is fixed in the axial center of the adjustment roller pair 80. The tension of the roll paper S nipped by the first adjustment roller 81 and second adjustment roller 82 can be adjusted by rotating the farther and nearer ends of the adjustment roller pair 80 in the directions indicated by the arrows in the figure.

FIG. 8B shows a case that the support shaft 84 is fixed on the farther side in the width direction of the roll paper S.

As shown in FIG. 8B, the support shaft 84 is fixed on the farther side in the axial direction of the adjustment roller pair 80. The nearer end of the adjustment roller pair 80 can be rotated in the directions indicated by the arrows in the figure so that the tension of the roll paper S nipped by the first adjustment roller 81 and second adjustment roller 82 can be adjusted.

FIG. 8C shows a case that the support shaft 84 is fixed on the nearer side in the width direction of the roll paper S.

As shown in FIG. 8C, the support shaft 84 is fixed on the nearer side in the axial direction of the adjustment roller pair 80. The farther end of the adjustment roller pair 80 can be rotated in the directions indicated by the arrows in the figure so that the tension of the roll paper S nipped by the first adjustment roller 81 and second adjustment roller 82 can be adjusted.

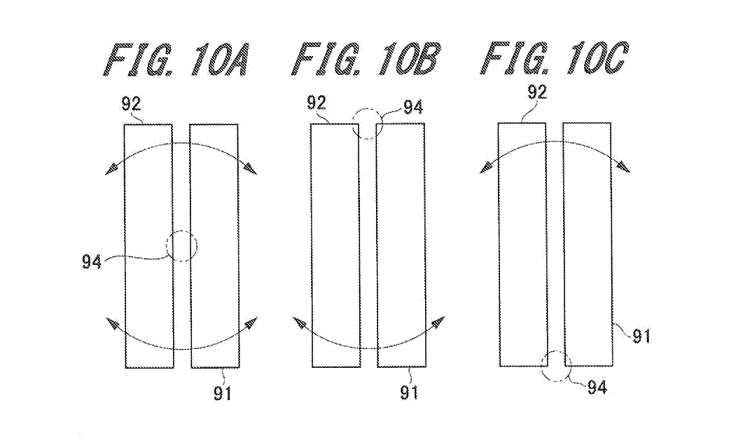

FIG. 9 is a perspective view of an adjustment roller pair 90 of the winding type.

As shown in FIG. 9, the adjustment roller pair 90 includes a first adjustment roller 91 and a second adjustment roller 92 provided above the first adjustment roller 91. The first adjustment roller 91 and second adjustment roller 92 are each a roller member whose axial length is larger than the widthwise length of the roll paper S.

The first adjustment roller 91 and second adjustment roller 92 are supported by a roller support 93 in a manner that the axes of the rollers are shifted from each other in the paper conveyance direction and parallel to each other. The roller support 93 includes a bottom part 93c provided along the conveyance direction of the roll paper S and sidewall parts 93a erected opposite to each other with the bottom part 93c sandwiched and these members form a U-shaped cross section in the width direction of the roll paper S.

A support shaft 94 which rotates the roller support 93 on a plane parallel to the surface of the roll paper S with the first adjustment roller 91 and second adjustment roller 92 supported is fixed on the bottom part 93c of the roller support 93. The support shaft 94 is connected to a rotation drive section 96 as a rotation controller. As the rotation drive section 96 rotates the support shaft 94, the roller support 93 fixed on the support shaft 94 rotates on the plane parallel to the surface of the roll paper S with the support shaft 94 as a rotation axis.

In this example, the first adjustment roller 91 in the lower position is located upstream in the conveyance path and the second adjustment roller 92 is located downstream and the roll paper S is wound around the first adjustment roller 91 and second adjustment roller 92 so that the paper conveyance path is S-shaped when viewed from the width direction of the roll paper S. This causes the roll paper S to be pressed toward the upstream side by the first adjustment roller 91 and pressed toward the downstream side by the second adjustment roller 92 so that a frictional force is generated between the first adjustment roller 91 and the roll paper S and between the second adjustment roller 92 and the roll paper S. Since the roll paper S rotates in conjunction with the rotation of the adjustment roller pair 90, the tension of the roll paper S can be adjusted by the adjustment roller pair 90.

FIGS. 10A to 10C are conceptual diagrams which show the movement of the adjustment roller pair 90 when the support shaft 94 is fixed in different positions.

FIG. 10A shows a case that the support shaft 94 is fixed in the widthwise center of the roll paper S.

As shown in FIG. 10A, the support shaft 94 is fixed in the axial center between the first adjustment roller 91 and second adjustment roller 92.

The support shaft 94 is connected to the rotation drive section 96 as a rotation controller. As the rotation drive section 96 rotates the support shaft 94, the roller support 93 fixed on the support shaft 94 rotates on the plane parallel to the surface of the roll paper S with the support shaft 94 as a rotation axis. Consequently, the tension of the roller paper S wound around the first adjustment roller 91 and second adjustment roller 92 can be adjusted by rotating the farther and nearer ends of the adjustment roller pair 90 in the directions indicated by the arrows in the figure.

FIG. 10B shows a case that the support shaft 94 is fixed on the farther side in the width direction of the roll paper S.

As shown in FIG. 10B, the support shaft 94 is fixed on the farther side in the axial direction between the first adjustment roller 91 and second adjustment roller 92. The nearer end of the adjustment roller pair 90 can be rotated in the directions indicated by the arrows in the figure so that the tension of the roll paper S wound around the first adjustment roller 91 and second adjustment roller 92 can be adjusted.

FIG. 10C shows a case that the support shaft 94 is fixed on the nearer side in the width direction of the roll paper S.

As shown in FIG. 10C, the support shaft 94 is fixed on the nearer side in the axial direction between the first adjustment roller 91 and second adjustment roller 92. The farther end of the adjustment roller pair 90 can be rotated in the directions indicated by the arrows in the figure so that the tension of the roll paper S wound around the first adjustment roller 91 and second adjustment roller 92 can be adjusted.

### [Correction of Meandering]

Next, the procedure of correcting meandering of the recording medium in the image forming apparatus 100 using the adjustment roller pair 80 will be described.

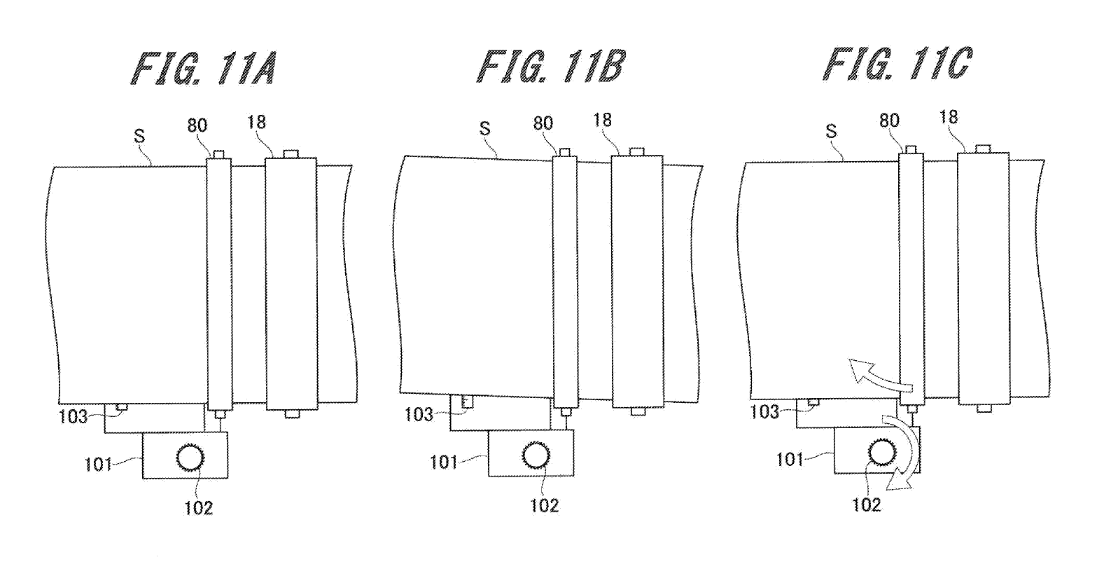

FIGS. 11A to 11C are top views which show the paper discharge roller pair 18 and its vicinity in the image forming apparatus 100 shown in FIG. 6.

The adjustment roller pair 80 is located downstream of and parallel to the paper discharge roller pair 18 in the paper conveyance direction with a given distance between the roller pairs. Preferably the adjustment roller pair 80 should be as close to (just under) the paper discharge roller pair 18 as possible. In this example, the support shaft 84 is located on the farther side in the width direction of the roll paper S and the nearer end of the adjustment roller pair 80 can be moved.

A plate 101 is connected to the nearer end of the adjustment roller pair 80 and the plate 101 is provided with an adjustment knob 102 as a gripper. In addition, an interlocking mechanism which interlocks the adjustment knob 102 with the support shaft 84 is provided under the plate 101. By rotating the adjustment knob 102, the support shaft 84 is rotated to move the nearer side of the adjustment roller pair 80. In this example, when the adjustment knob 102 is rotated clockwise, the nearer end of the adjustment roller pair 80 is moved downstream in the paper conveyance direction. When the adjustment knob 102 is rotated counterclockwise, the nearer end of the adjustment roller pair 80 is moved upstream in the paper conveyance direction.

A guide scale 103 as a deviation detector which enables the operator to visually check for a positional deviation of the longitudinal end of the roll paper S being conveyed is provided downstream of the adjustment roller pair 80 on the nearer side in the conveyance path. The guide scale 103 is attached to a guide plate constituting the conveyance path and is a long member which extends perpendicularly to the paper conveyance direction. The surface of the guide scale 103 is graduated in increments of 1 mm with the farther side in the width direction of the roll paper S as a reference position.

If the paper discharge roller pair 18 is not out of alignment and the roll paper S is not meandering, the end of the roll paper S passes the position on the guide scale 103 as shown in FIG. 11A (for example, the position of the graduation 330 mm).

If the paper discharge roller pair 18 gets out of alignment due to the motion of coming into contact with or leaving the paper or the like, the end of the roll paper S passes the position on the guide scale 103 as shown in FIG. 11B (for example, the position of the graduation 326 mm). The operator can know that a misalignment has occurred in which the distance of the farther end of the paper discharge roller pair 18 from the fixing roller pair 11 has increased and thus the tension of the farther side of the roll paper S in the width direction has become higher, resulting in meandering of the roll paper S toward the farther side.

The operator, who has recognized meandering through the guide scale 103, rotates the adjustment knob 102 clockwise as indicated by the arrows in FIG. 11C so as to increase the distance of the nearer end of the adjustment roller pair 80 from the paper discharge roller pair 18. Consequently, the distance between the nearer end of the adjustment roller pair 80 and the nearer end of the paper discharge roller pair 18 becomes larger and thus the tension of the nearer side of the roll paper S in the width direction becomes higher. As a result, the roll paper S moves towards the nearer side in the width direction, which offsets the meandering caused by misalignment of the paper discharge roller pair 18.

The operator confirms that the end of the roll paper S passes the position on the guide scale 103 as shown in FIG. 11C (for example, the position of the graduation 330 mm) and ends the meandering correction work.

In this example, the operator can correct meandering of the roll paper S reliably by rotating the adjustment knob 102 while checking the position of the end of the roll paper S through the guide scale 103. In this example, the operator manually rotates the adjustment knob 102; however, instead the adjustment knob 102 may be rotated automatically under the control by the controller 60.

If misalignment of the paper discharge roller pair 18 causes the roll paper S to meander toward the nearer side in the width direction, the operator rotates the adjustment knob 102 counterclockwise so that the nearer end of the adjustment roller pair 80 becomes closer to the paper discharge roller pair 18. Consequently, the farther end of the adjustment roller pair 80 moves in a manner to increase the distance from the paper discharge roller pair 18 and thus the tension of the farther side of the roll paper S in the width direction becomes higher. As a result, the roll paper S moves (meanders) toward the farther side in the width direction of the roll paper S so that the meandering caused by the misalignment of the paper discharge roller pair 18 can be corrected.

As mentioned above, in the image forming apparatus 100 according to the first embodiment, the adjustment roller pair 80 is located not upstream of the paper discharge roller pair 18 but downstream of the paper discharge roller pair 18, namely the adjustment roller pair 80 is located on the most downstream side of the plurality of roller pairs which can come into contact with and leave the paper, so that meandering of the roll paper S which is caused, for example, by misalignment of the paper discharge roller pair 18 located on the most downstream side can be corrected. In addition, meandering caused by misalignment of the roller pair located on the most upstream side can also be corrected.

Furthermore, if the paper discharge roller pair 18 located on the most downstream side can be rotated, it may be used as a roller pair for the tension adjuster. This makes it possible to correct meandering of the roll paper S caused by misalignment without the need to newly install an adjustment roller.

Next, a variation of the first embodiment will be described in which the adjustment roller pair 80 is located on the most upstream side of a plurality of roller pairs which can come into contact with and leave the paper.

FIG. 12 is a schematic diagram of the image forming apparatus 100 shown in FIG. 1. As shown in FIG. 12, in the conveyance path in the image forming main unit 1, the adjustment roller pair 80, transfer roller pair 71, fixing roller pair 11, and paper discharge roller pair 18 are arranged in order from upstream. In this example, the adjustment roller pair 80 is located upstream of the transfer roller pair 71 as the most upstream roller pair. The transfer roller pair 71, fixing roller pair 11, and paper discharge roller pair 18 are structured to be able to come into contact with and leave the paper being conveyed and these rollers may get out of alignment while they are moving to come into contact with or leave the paper. In this example, meandering of the roll paper S as mainly caused by misalignment of the transfer roller pair 71 can be corrected using the adjustment roller pair 80 located upstream of the transfer roller pair 71.

In this example too, if the transfer roller pair 71 located on the most upstream side can be rotated, it may be used as a roller pair for the tension adjuster. Preferably the adjustment roller pair 80 should be located as close to (just above) the transfer roller pair 71 as the most upstream roller pair as possible.

Next, a second embodiment in which the present invention is applied to an ink jet image forming apparatus will be described.

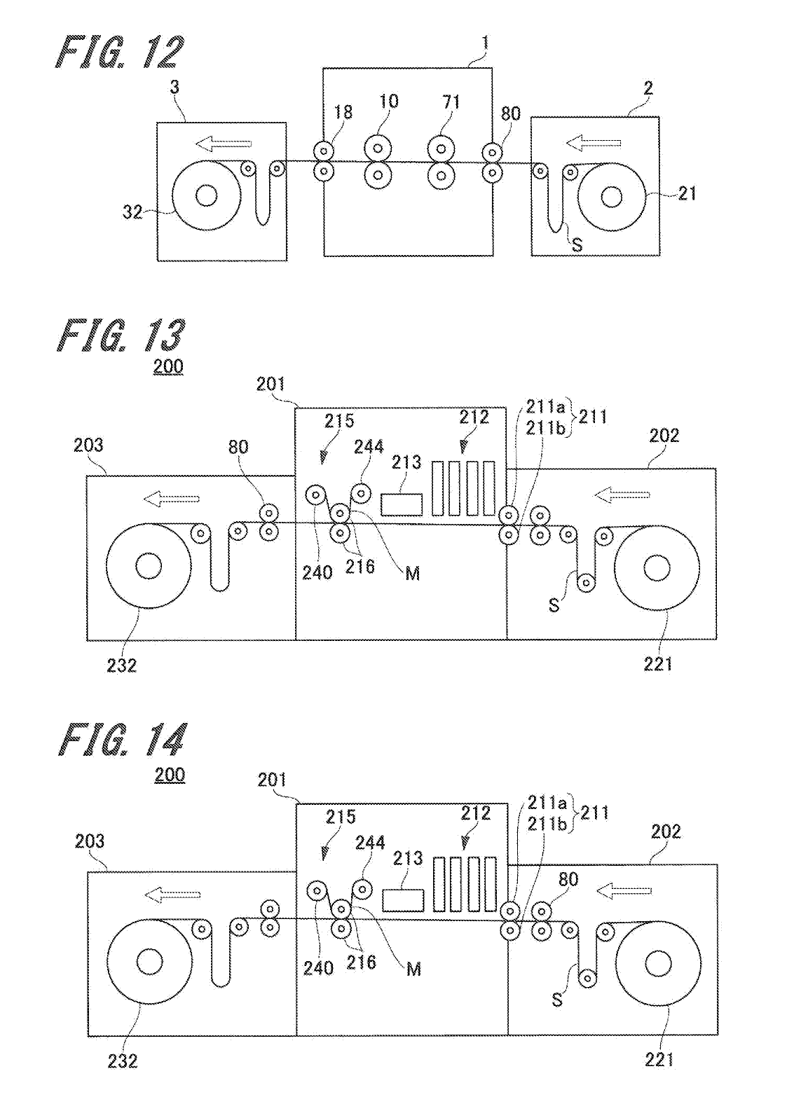

FIG. 13 is a schematic configuration diagram of an ink jet recorder 200.

As shown in FIG. 13, the ink jet recorder 200 includes an image forming main unit 201, a paper feed unit 202 with a conveyor 221, and a paper discharge unit 203 with a take-up part 232.

In the conveyance path in the image forming main unit 201, a preheat section 211 including a pair of rollers for preheating the paper, a transfer section 212 with an ink head for injecting ink to the paper heated by the preheat rollers 211, an ink image fixing section 213 for fixing the image of injected ink on the paper, and a foil image forming section 215 for transferring a foil of a foil transfer sheet to the paper to form a foil image are arranged in order from upstream.

The preheat section 211 is a preheat roller pair which includes a fixing roller 211a with a heat source and a pressure roller 211b as a pressurizing member.

The area where the fixing roller 211a and pressure roller 211b come into contact with each other forms a nip part. As the roll paper S passes through the nip part of the preheat section 211, the roll paper S is heated by the fixing roller 211a and pressure roller 211b which are controlled at a prescribed temperature. The preheat roller pair 211 can come into contact with and leave the roll paper S and is structured to come into contact with the roll paper S only when it is necessary to heat the roll paper S.

The foil image forming section 215 includes foil transfer nip rollers 216 as a roller pair for nipping the roll paper S, a foil feed spool 240 for supplying a foil transfer sheet H to the foil transfer nip rollers 216, and a disposal spool 244 for collecting unrequired foil from the foil transfer nip rollers 216. The foil transfer nip rollers 216 press the foil transfer sheet H supplied from the foil feed spool 240 against the paper to form a foil image. The foil transfer nip rollers 216 can come into contact with and leave the roll paper S and are structured to come into contact with the roll paper S only when a foil image is to be formed.

In other words, since a plurality of roller pairs 211 and 215 which can come into contact with and leave the roll paper S are provided in the image forming main unit 201, the preheat roller pair 211 and the foil transfer nip roller pair 216 may get out of alignment while they are moving to come into contact with or leave the paper, causing the roll paper S to meander.

In this example, as shown in FIG. 13, an adjustment roller pair 80 is provided downstream of the foil transfer nip roller pair 216 as the most downstream roller pair. The adjustment roller pair 80, located on the most downstream side, can correct meandering of the roll paper S as mainly caused by misalignment of the foil transfer nip roller pair 216.

FIG. 14 shows a variation of the second embodiment as the ink jet recorder 200 shown in FIG. 13. As shown in FIG. 14, in the paper conveyance path of the ink jet recorder 200, the adjustment roller pair 80, preheat roller pair 211, transfer section 212, fixing section 213, and foil transfer roller pair 216 are arranged in order from upstream. In other words, in this example, the adjustment roller pair 80 is located upstream of the preheat roller pair 211 as the most upstream roller pair.

In this example, the adjustment roller pair 80, located on the most upstream side, can correct meandering of the roll paper S as mainly caused by misalignment of the preheat roller pair 211.

As explained above, when the paper is conveyed while a tension is uniformly applied to a plurality of roller pairs which can come into contact with and leave the paper, meandering of the paper as caused by misalignment of a roller pair can be corrected by using the adjustment roller pair according to the present invention which is located on the most upstream or most downstream side of the area where the tension is uniformly applied.

Next, the sequence of correcting meandering of the roll paper S will be described.

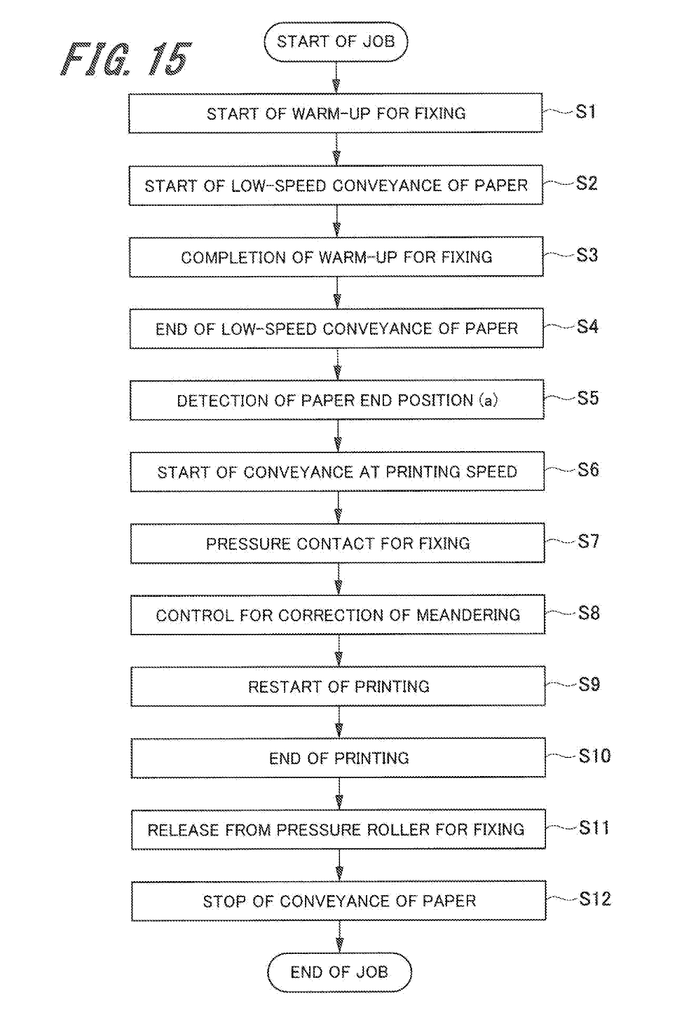

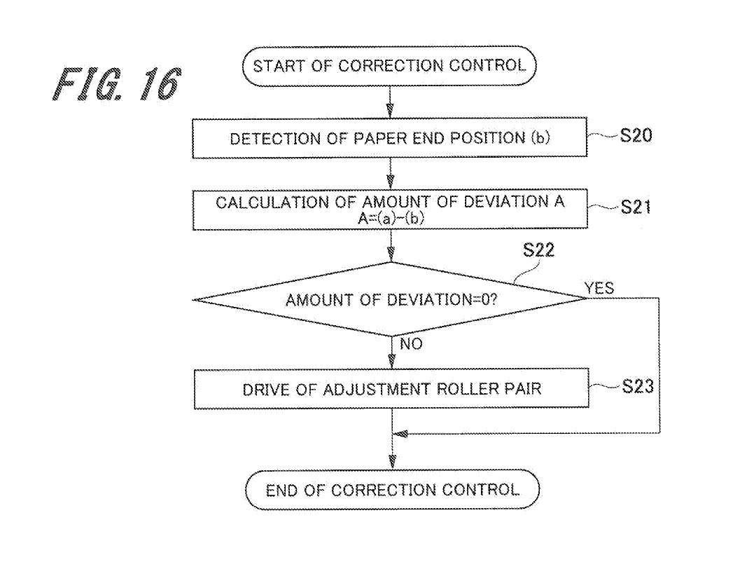

FIG. 15 is a flowchart which shows the sequence of correcting meandering of the paper in the image forming apparatus 100 according to the first embodiment.

As shown in FIG. 15, when a job start command is received from the operation display or PC (not shown) of the image forming apparatus 100, warm-up for fixing is started under the control by the controller 60 (Step S1). At the same time the warm-up for fixing is started, low-speed conveyance of the roll paper S is started (Step S2). Specifically, when the fixing roller 11a of the fixing section 10 is pressed against the pressure roller 11b and the roll paper S is held by the nip part between the rollers, low-speed conveyance of the roll paper S is started. After the roll paper S is nipped by the fixing section 10, the roll paper S is conveyed from the paper feed unit 2 to the paper discharge unit 3 under the control by the controller 60. At this time, the paper is conveyed at a lower speed than the normal paper conveyance speed for printing.

After a prescribed time has elapsed or after the warm-up for fixing is finished (Step 3), the low-speed conveyance of the roll paper S at Step S2 is ended (Step S4). Then, the position (a) of the widthwise end of the roll paper S at the time of the end of low-speed conveyance at Step S4 is detected, for example, at the post-discharge sensor 17 as a position detector and the result of detection is sent to the arithmetic section 29 (Step S5).

After position detection of the end of the roll paper S at Step S5 is finished, under the control by the controller 60 printing is started and conveyance of the roll paper S from the paper feed unit 2 to the paper discharge unit 3 at a higher speed than the paper conveyance speed during warm-up for fixing is started (Step S6).

As printing is started, a toner image is formed on the intermediate transfer belt 50 by the image forming section according to an image signal received, for example, from an external device. The toner image formed on the intermediate transfer belt 50 is transferred onto the roll paper S by the secondary transfer part 70 and fixed on the roll paper S at the fixing section 10 (Step S7).

Then, after a prescribed time has elapsed after the start of conveyance of the roll paper S from the paper feed unit 2 to the paper discharge unit 3, control for correction of meandering is started under the control by the controller 60 (Step S8). The control for correction of meandering will be described later referring to FIG. 16. Alternatively, the control for correction of meandering may be started, for example, each time the roll paper S moves forward by a prescribed length, instead of upon the lapse of a prescribed time after the start of conveyance of the roll paper S.

After the control for correction of meandering at Step S8 is finished, printing is restarted (Step S9). After the target job is achieved, under the control by the controller 60 image formation in the image forming section is stopped to end printing (Step S10).

After that, under the control by the controller 60, in the fixing section 10 the pressure roller 11b is separated from the fixing roller 11a to end the fixing operation (Step S11) and then the conveyance of the roll paper S is stopped (Step S12) to end the job.

Next, the control for correction of meandering at Step S8 shown in FIG. 15 will be explained on the assumption that the correction is automatically made by the controller 60.

FIG. 16 is a flowchart which shows the sequence of control for correction of meandering according to the first embodiment.

The control for correction of meandering is started upon issuance of a meandering correction command at Step S8 in FIG. 15. In the control for correction of meandering, under the control by the controller 60 the position (b) of the end of the roll paper S at the time of issuance of the meandering correction command is detected at the post-discharge sensor 17 (Step S20).

Then, the amount of deviation A of the roll paper S (A=a−b) is calculated as the difference between the position (b) detected at Step S20 and the position (a) detected at Step S5 in FIG. 15 (Step S21).

Then, a determination is made as to whether the amount of meandering A of the roll paper S calculated at Step S21 is zero or not (Step S22).

If the determination is “YES” at Step S22, it means that the roll paper S is not meandering and the control for correction of meandering is ended.

If the determination is “NO” at Step S21, it means that the roll paper S is meandering due to misalignment of the paper discharge roller pair or the like and thus meandering is corrected using the adjustment roller pair 80 as a tension adjuster (Step S23).

Specifically, under the control by the controller 60 the amount of deviation A determined at Step S22 is sent to the arithmetic section 29 and the arithmetic section 29 as a rotation amount calculator calculates the required amount of rotation of the support shaft 84 which depends on the amount of deviation A and causes the rotation drive section 86 to rotate the adjustment roller pair 80. A table stored in the RAM 63 of the controller 60 which determines the amount of rotation for each type of recording medium may be used to calculate the amount of rotation.

In order to determine the direction of rotation of the adjustment roller pair 80, under the control by the controller 60 the comparator 30 determines whether the amount of deviation A (a−b) of the roll paper S at the position of the post-discharge sensor 17 is positive or negative. If the amount of deviation a of the roll paper S is larger than the amount of deviation b (the amount of deviation A is positive), the roll paper S is judged to be meandering toward the nearer side in the paper width direction and if the amount of deviation b of the roll paper S is larger than the amount of deviation a (the amount of deviation A is negative), the roll paper S is judged to be meandering toward the farther side in the paper width direction. The direction of rotation of the adjustment roller pair 80 is determined according to the above determination.

Although the post-discharge sensor 17 is used as a position detector in this example, instead the post-transfer sensor 15 or post-fixing sensor 16 may be used as a detection sensor as appropriate.

As explained so far, in the image forming apparatus according to the first embodiment, the adjustment roller pair 80 or 90 is located upstream of the most upstream roller pair in the conveyance path of the image forming apparatus or downstream of the most downstream roller pair on the most downstream side so that meandering of the paper as caused by misalignment of the paper discharge roller pair, transfer roller pair or the like can be corrected.

In the description of the above embodiments, details have been given for easy understanding of the present invention; however the invention is not limited to an apparatus which includes all the elements described above. For example, an element of one embodiment may be replaced by an element of another embodiment or an element of one embodiment may be added to another embodiment. For an element of each embodiment, addition, deletion, or replacement of another element can be made.

Although each of the above embodiments has been described as a color image forming apparatus, the present invention may also be applied to a monochrome image forming apparatus.

The adjustment roller pairs 80 and 90 in the above embodiments are just examples and any type of adjustment roller pair that can rotate in the paper conveyance direction may be used. For example, the first adjustment roller and second adjustment roller may be driven separately.

Furthermore, although in the first embodiment the most upstream roller pair is the transfer roller pair 71 and the most downstream roller pair is the paper discharge roller pair 18, the present invention may also be applied to an apparatus in which the most upstream roller pair and most downstream roller pair are conveying roller pairs which can come into contact with or leave the paper. Although embodiments of the present invention have been described and illustrated in detail, the disclosed embodiments are made for purposes of illustration and example only and not limitation. The scope of the present invention should be interpreted by terms of the appended claims

### REFERENCE SIGNS LIST

1 . . . image forming main unit,
2 . . . paper feed unit,
3 . . . paper discharge unit,
10 . . . fixing section,
11 . . . fixing roller pair,
15 . . . post-transfer sensor,
16 . . . post-fixing sensor,
17 . . . post-discharge sensor,
18 . . . paper discharge roller pair,
29 . . . arithmetic section,
60 . . . controller,
70 . . . secondary transfer part,
71 . . . transfer roller pair,
74 . . . pre-transfer sensor,
80, 90 . . . adjustment roller pair,
86, 96 . . . rotation drive section,
100 . . . image forming apparatus,
102 . . . adjustment knob,
103 . . . guide scale,
200 . . . ink-jet recorder

What is claimed is:

1. An image forming apparatus conveying a recording medium along a conveyance path, comprising:
a plurality of roller pairs provided along the conveyance path and capable of coming into contact with and leaving the recording medium; and
a tension adjuster for adjusting a tension applied to the recording medium held between the plural roller pairs,
wherein the tension adjuster is located upstream of, among the plural roller pairs, a most upstream roller pair located on a most upstream side in the conveyance path or downstream of a most downstream roller pair located on a most downstream side in the conveyance path and rotates in a direction of conveyance of the recording medium to adjust the tension of the recording medium.

2. The image forming apparatus according to claim 1, wherein the tension adjuster includes roller members which nip the recording medium by a nip part and convey the recording medium.

3. The image forming apparatus according to claim 1, wherein the tension adjuster includes roller members around which the recording medium is wound to be conveyed.

4. The image forming apparatus according to claim 2, wherein the tension adjuster is a paper discharge roller pair which discharges the recording medium downstream.

5. The image forming apparatus according to claim 1, further comprising a measuring section to measure a position of a widthwise end of the recording medium in the conveyance path.

6. The image forming apparatus according to claim 5, further comprising a gripper for rotating the tension adjuster in the direction of conveyance of the recording medium.

7. The image forming apparatus according to claim 1, further comprising:
a deviation detector for detecting an amount of deviation of a longitudinal end of the recording medium; and
a rotation controller for rotating the tension adjuster according to the amount of deviation detected by the deviation detector.

8. The image forming apparatus according to claim 7, further comprising a rotation amount calculator for calculating an amount of rotation to rotate the tension adjuster according to the amount of deviation detected by the deviation detector.

9. The image forming apparatus according to claim 1, wherein the plural roller pairs at least include a transfer roller pair and a fixing roller pair located downstream of the transfer roller pair.
